(19) United States
(12) Patent Application Publication
(10) Pub. No.: US 2024/0006838 A1
(43) Pub. Date: Jan. 4, 2024

(54) APPARATUS FOR AND METHOD OF MODULATING A WAVELENGTH OF AN EXCIMER LASER AS A FUNCTION OF ITS REPETITION FREQUENCY

(71) Applicant: Cymer, LLC, San Diego, CA (US)

(72) Inventors: James Michael Simonelli, San Diego, CA (US); Kuo-Tai Teng, Poway, CA (US)

(21) Appl. No.: 18/039,619

(22) PCT Filed: Dec. 2, 2021
(86) PCT No.: PCT/US2021/061536

§ 371 Date: May 31, 2023

Related U.S. Application Data
(60) Provisional application No. 63/126,230, filed on Dec. 16, 2020.

(51) Int. Cl. H01S 3/225; H01S 3/10; H01S 3/13; H01S 3/08

(52) U.S. Cl. CPC H01S 3/225; H01S 3/10046; H01S 3/10069; H01S 3/1305; H01S 3/08004

(57) ABSTRACT

Apparatus for and methods of controlling wavelength in a system for producing laser radiation at more than one wavelength (color) in which one or more actuators control wavelength in response to being supplied with a waveform. The characteristics of the waveform, and/or of a controller for controlling the waveform, are determined based on a current repetition rate of the laser. A current repetition rate is determined and if it is new then a new waveform is commanded. Also disclosed is a system in which a correction depending on repetition rate is applied to an ILC algorithm determining a wavelength.

### CROSS REFERENCE TO RELATED APPLICATIONS

This application claims priority to U.S. Application No. 63/126,230, filed Dec. 16, 2020, titled APPARATUS FOR AND METHOD OF MODULATING A LIGHT SOURCE WAVELENGTH, which is incorporated herein in its entirety by reference.

### FIELD

The present disclosure relates to laser systems such as excimer lasers that produce light and systems and methods for controlling a center wavelength thereof.

### BACKGROUND

A lithographic apparatus applies a desired pattern onto a substrate such as a wafer of semiconductor material, usually onto a target portion of the substrate. A patterning device, which is alternatively referred to as a mask or a reticle, may be used to generate a circuit pattern to be formed on an individual layer of the wafer. Transfer of the pattern is typically accomplished by imaging onto a layer of radiation-sensitive material (resist) provided on the substrate. In general, a single substrate will contain adjacent target portions that are successively patterned.

Lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning” direction) while synchronously scanning the substrate parallel or anti-parallel to this direction. It is also possible to transfer the pattern from the patterning device to the substrate by imprinting the pattern onto the substrate. Herein, for the sake of simplicity, both steppers and scanners will be referred to simply as scanners.

The light source used to illuminate the pattern and project it onto the substrate can be of any one of a number of configurations. Deep ultraviolet excimer lasers commonly used in lithography systems include the krypton fluoride (KrF) laser at 248 nm wavelength and the argon fluoride (ArF) laser at 193 nm wavelength.

To project a pattern on a substrate, a lithographic apparatus may use electromagnetic radiation. The wavelength of this radiation determines the minimum size of features which can be formed on the substrate. A lithographic apparatus may use extreme ultraviolet (EUV) radiation, having a wavelength within the range of 4-20 nm, for example 6.7 nm or 13.5 nm, or deep ultraviolet (DUV) radiation, having a wavelength in the range of about 120 to about 400 nm, for example 193 or 248 nm.

The lithographic apparatus may operate at a single wavelength in what may be referred to as a single-color mode. For some applications, however, it is desired to have the ability to change wavelength. For example, in 3D NAND tiers of memory (that is, memory in which the structure resembles NAND (not AND) gates stacked on top of each other). The transition from 2D to 3D NAND architecture requires significant changes in manufacturing processes. In 3D NAND fabrication, the challenges are driven primarily by the processes of etching and deposition at extreme aspect ratios (ratio of a hole diameter to its depth). Creating complex 3D structures with very high-aspect-ratio (HAR) features is complicated and requires extreme precision and, ultimately, process uniformity and repeatability to achieve scale. Moreover, as multi-layered stack heights increase, so does the difficulty in achieving consistent etch and deposition results at the top and the bottom of the stack, e.g., a memory array.

These considerations lead to a need for a greater depth of focus. Lithography depth of focus (DoF) is determined by the relationship DOF=±m2λ/(NA)² where λ is the wavelength of the illuminating light, NA is numerical aperture, and m1 and m2 are practical factors depending on the resist process. Due to greater depth-of-focus requirements in 3D NAND lithography, sometimes more than one exposure pass is made over a wafer using a different laser wavelength for each pass. Multi Focus Imaging (MFI) uses multiple focus levels (e.g., via multiple wavelengths) to effectively increase DoF for a given numerical aperture (NA) of the objective lens. This enables the imaging NA, and therefore exposure latitude (process window), to be increased while the DoF can be optimized by MFI in accordance with production layer needs.

In addition, the materials making up the lenses that focus the laser radiation are dispersive, so different wavelengths come to focus at different depths. This is another reason why it may be desirable to have the ability to change wavelengths.

In a single-color mode, two actuators, i.e., a stepper motor and a Piezoelectric transducer (PZT), work in conjunction with one another to stabilize the center wavelength. In operation, the stepper motor has limited resolution, and as such, the PZT is used as the primary actuator. However, in a two-color mode, wavelength stability is based on a central wavelength, i.e., a mean of two alternating spectra, and in this mode, the PZT is tasked with the production of the waveform that generates the alternating wavelengths.

As a specific example, in an application of generating DUV light at two different wavelengths, the reference wavelength has two set points during exposure, that is, a first set point at a first wavelength and a second set point at a second wavelength. The reference wavelength will then be modulated between these two set points. Every wavelength target change requires a predetermined settling time.

A DUV light source includes systems for controlling the wavelength of the DUV light. Typically, these wavelength control systems include feedback and feed-forward compensators to promote wavelength stability. The feed-forward compensator compensates for commanded changes in the wavelength target, that is, wavelength change events. When such an event occurs, a settling time must be allowed for the system to settle stably to the new wavelength.

Typically, an MFI algorithm presumes the laser will be operated in MFI mode only at (or substantially near) a specific repetition rate, e.g., 6 kHz, and so calibrates and optimizes the base waveform for the PZT dither for performance at this single operation point. This base waveform is then modified burst-to-burst using an iterative learning control (ILC) algorithm to compensate for drifts and operation (reasonably) outside the anticipated operation points.

The assumption that there will be only a single repetition rate over the entire wafer, however, may not hold in certain use cases. For example, it may be that the repetition rate may be drastically changed for fields near the edges of the wafer. To the extent an algorithm such as an ILC algorithm is built on the assumption that the repetition rate for each successive field will be similar to (i.e., not to different from) to the repetition rate for the previous field, inclusion of such lower repetition rate fields may introduce a long-lasting corruption into the learned compensation that can lead to wafer scrap.

The assumption that a single repetition rate will be used over the entire wafer is requirement also restricts the range of repetition rates available even at the center of the wafer, which can adversely affect the scanner's dose control optimization—in the worst case, potentially causing the dose controller to be unable to come to a solution, halting production.

### SUMMARY

The following presents a simplified summary of one or more embodiments in order to provide a basic understanding of the embodiments. This summary is not an extensive overview of all contemplated embodiments and is not intended to identify key or critical elements of all embodiments nor delineate the scope of any or all embodiments. Its sole purpose is to present some concepts of one or more embodiments in a simplified form as a prelude to the more detailed description that is presented later.

According to an aspect of an embodiment, there is disclosed a laser system comprising a trigger circuit for firing the laser system in at least two bursts, a first burst including a plurality of first burst pulses fired at a first repetition rate and a second burst including a plurality of second burst pulses fired at a second repetition rate, a wavelength control device adapted to control a wavelength of each pulse of the first burst pulses in response to a first applied waveform and of each pulse of the second burst pulses in response to a second applied waveform, and a comparator for performing a comparison between the second repetition to the first repetition rate and for determining one or more parameters of the second applied waveform at least partially on the basis of the comparison. The comparator may determine to use a second applied waveform different from the first applied waveform if the second repetition rate is different from the first repetition rate. The comparator may determine to use a second applied waveform the same as the first applied waveform if the second repetition rate is the same as the first repetition rate. The comparator may compute one or more parameters for the second applied waveform using the second repetition rate as an input. The comparator may comprise a field programmable gate array that determines one or more parameters for the second applied waveform based at least in part on the second repetition rate. The comparator may comprise a memory having a look-up table where the look-up table returns one or more parameters for the second applied waveform based on the second repetition rate. The one or more parameters may include a magnitude of an amplitude of the second burst waveform, a time variation of a magnitude of an amplitude of the second burst waveform, and/or a correction to a feedback algorithm for the second burst waveform. The feedback algorithm may be an iterative learning control algorithm.

According to another aspect of an embodiment, the comparator may apply the second applied waveform to the second burst after a plurality of first trigger pulses in the second burst used to compute the second repetition rate. The comparator may apply the second applied waveform to the second burst after two first trigger pulses in the second burst used to compute the second repetition rate. The comparator may apply a first trigger waveform to the second burst during the plurality of first trigger pulses in the second burst used to compute the second repetition rate. The comparator may apply the first applied waveform as the first trigger waveform. The comparator may apply a default waveform as the first trigger waveform. The comparator may apply a constant level as the first trigger waveform.

According to another aspect of an embodiment, the laser system may further comprise a transition management unit for managing a transition between the first trigger waveform and the second applied waveform. The transition management unit may mange the transition between the first trigger waveform and the second applied waveform by cross fading the first trigger waveform and the second applied waveform. The transition management unit may mange the transition between the first trigger waveform and the second applied waveform by switching from the first trigger waveform to the second applied waveform at a zero crossing of the first trigger waveform. The transition management unit may mange the transition between the first trigger waveform and the second applied waveform by switching from the first trigger waveform to the second applied waveform at a local maximum or minim of the first trigger waveform.

According to another aspect of an embodiment, there is disclosed a method of controlling a laser system, the method comprising firing the laser system in a first burst including a plurality of first burst pulses fired at a first repetition rate, initiating firing the laser system in a second burst including a plurality of second burst pulses while determining a second repetition rate at which the second burst pulses are fired, using the second repetition rate to determine one or more parameters for a second burst waveform for an actuator determining wavelengths of the second burst pulses, and applying the second burst waveform to the actuator. Using the second repetition rate to determine one or more parameters for a second burst waveform may comprise determining one or more parameters for the second burst waveform different from one or more parameters of the first burst waveform. Using the second repetition rate to determine one or more parameters for a second burst waveform may comprise determining parameters for the second burst waveform which are the same as the parameters of the first burst waveform. Using the second repetition rate to determine one or more parameters for a second burst waveform for an actuator determining wavelengths of the second burst pulses may comprise computing parameters for the second burst waveform using the second repetition rate as an input. Using the second repetition rate to determine one or more parameters for a second burst waveform for an actuator determining wavelengths of the second burst pulses may comprise using the second repetition rate as an input to a field programmable gate array to determine parameters for the second burst waveform. Using the second repetition rate to determine one or more parameters for a second burst waveform for an actuator determining wavelengths of the second burst pulses may comprise using the second repetition rate to look up parameters for the second burst waveform in a look-up table. The one more parameters may include a magnitude of an amplitude of the second burst waveform, a time variation of a magnitude of an amplitude of the second burst waveform, and/or a correction to a feedback algorithm for the second burst waveform. The feedback algorithm may be an iterative learning control algorithm.

According to another aspect of an embodiment, the method may further comprise using a plurality of first trigger pulses in the second burst to compute the second repetition rate before using the second repetition rate to determine one or more parameters for a second burst waveform for an actuator determining wavelengths of the second burst pulses. The method may further comprise applying a first trigger waveform to the second burst during the plurality of first trigger pulses in the second burst used to compute the second repetition rate. Applying a first trigger waveform may comprise applying the first burst waveform. Applying a first trigger waveform may comprise applying a default waveform. Applying a first trigger waveform may comprise applying a first trigger waveform to the second burst during the plurality of first trigger pulses in the second burst used to compute the second repetition rate. Applying a first trigger waveform may comprise applying first applied waveform as the first trigger waveform. Applying a first trigger waveform may comprise applying a default waveform as the first trigger waveform. Applying a first trigger waveform may comprise applying a constant level as the first trigger waveform.

According to another aspect of an embodiment, the method may further comprise managing a transition between the first trigger waveform and the second applied waveform. Managing a transition between the first trigger waveform and the second applied waveform may comprise cross fading the first trigger waveform and the second applied waveform. Managing a transition between the first trigger waveform and the second applied waveform may comprise switching from the first trigger waveform to the second applied waveform at a zero crossing of the first trigger waveform. Managing a transition between the first trigger waveform and the second applied waveform may comprise switching from the first trigger waveform to the second applied waveform at a local maximum or minim of the first trigger waveform.

Further features and exemplary aspects of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the embodiments and, together with the description, further serve to explain the principles of the embodiments and to enable a person skilled in the relevant art(s) to make and use the embodiments.

FIG. 1 is a schematic illustration of a lithographic apparatus, according to an exemplary embodiment.

FIG. 2 is a schematic top plan illustration of a light source apparatus, according to an exemplary embodiment.

FIG. 3 is a schematic partial cross-sectional illustration of a gas discharge stage of the light source apparatus shown in FIG. 2, according to an exemplary embodiment.

FIG. 4 is a schematic partial cross-sectional illustration of a gas discharge stage of the light source apparatus shown in FIG. 2, according to an exemplary embodiment.

FIG. 5 is a conceptual drawing of a system for providing wavelength control according to an aspect of an embodiment.

FIG. 6 is a flowchart showing steps of a process for providing wavelength control according to an aspect of an embodiment.

FIG. 7 is a flowchart showing steps of a part of a process for providing wavelength control according to an aspect of an embodiment.

FIG. 8 is a graph of an actuator waveform in relation to laser pulses.

FIG. 9A is a graph of an actuator waveform in relation to laser pulses.

FIG. 9B is a graph of an actuator waveform in relation to laser pulses.

FIG. 10A is a graph of an actuator waveform in relation to laser pulses.

FIG. 10B is a graph of an actuator waveform in relation to laser pulses.

FIG. 11 is a flowchart showing steps of a part of a process for providing waveform control according to an aspect of an embodiment.

FIG. 12A is a conceptual drawing of a system for providing waveform control according to an aspect of an embodiment.

FIG. 12B is a conceptual drawing of a system for providing waveform control according to an aspect of an embodiment.

FIG. 13 is a flowchart showing steps of a part of a process for providing ILC correction control according to an aspect of an embodiment.

FIG. 14A is a conceptual drawing of a system for providing ILC correction control according to an aspect of an embodiment.

FIG. 14B is a conceptual drawing of a system for providing ILC correction control according to an aspect of an embodiment.

FIG. 15 is a functional block diagram of a computer control system according to an aspect of an embodiment.

The features and exemplary aspects of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

This specification discloses one or more embodiments that incorporate the features of this present invention. The disclosed embodiment(s) merely exemplify the present invention. The scope of the invention is not limited to the disclosed embodiment(s). The present invention is defined by the claims appended hereto.

The embodiment(s) described, and references in the specification to “one embodiment,” “an embodiment,” “an exemplary embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Spatially relative terms, such as “beneath,” “below,” “lower,” “above,” “on,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The term “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value).

Embodiments of the disclosure may be implemented in hardware, firmware, software, or any combination thereof. Embodiments of the disclosure may also be implemented as instructions stored on a tangible machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present disclosure may be implemented.

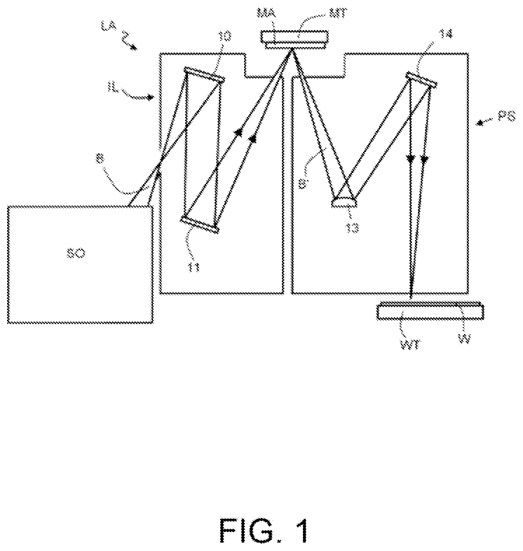

FIG. 1 shows a lithographic system comprising a radiation source SO and a lithographic apparatus LA. The radiation source SO is configured to generate an EUV and/or a DUV radiation beam B and to supply the EUV and/or DUV radiation beam B to the lithographic apparatus LA. The lithographic apparatus LA comprises an illumination system IL, a support structure MT configured to support a patterning device MA (e.g., a mask), a projection system PS, and a substrate table WT configured to support a substrate W.

The illumination system IL is configured to condition the EUV and/or DUV radiation beam B before the EUV and/or DUV radiation beam B is incident upon the patterning device MA. Thereto, the illumination system IL may include a faceted field mirror device 10 and a faceted pupil mirror device 11. The faceted field mirror device 10 and faceted pupil mirror device 11 together provide the EUV and/or DUV radiation beam B with a desired cross-sectional shape and a desired intensity distribution. The illumination system IL may include other mirrors or devices in addition to, or instead of, the faceted field mirror device 10 and faceted pupil mirror device 11.

After being thus conditioned, the EUV and/or DUV radiation beam B interacts with the patterning device MA (e.g., a transmissive mask for DUV, or a reflective mask for EUV). As a result of this interaction, a patterned EUV and/or DUV radiation beam B′ is generated. The projection system PS is configured to project the patterned EUV and/or DUV radiation beam B′ onto the substrate W. For that purpose, the projection system PS may comprise a plurality of mirrors 13, 14 which are configured to project the patterned EUV and/or DUV radiation beam B′ onto the substrate W held by the substrate table WT. The projection system PS may apply a reduction factor to the patterned EUV and/or DUV radiation beam B′, thus forming an image with features that are smaller than corresponding features on the patterning device MA. For example, a reduction factor of 4 or 8 may be applied. Although the projection system PS is illustrated as having only two mirrors 13, 14 in FIG. 1, the projection system PS may include a different number of mirrors (e.g., six or eight mirrors).

The substrate W may include previously formed patterns. Where this is the case, the lithographic apparatus LA aligns the image, formed by the patterned EUV and/or DUV radiation beam B′, with a pattern previously formed on the substrate W.

A relative vacuum, i.e., a small amount of gas (e.g., hydrogen) at a pressure well below atmospheric pressure, may be provided in the radiation source SO, in the illumination system IL, and/or in the projection system PS.

As discussed above, a master oscillator power amplifier (MOPA) is a two-stage optical resonator arrangement. The master oscillator (MO) (e.g., first optical resonator stage) produces a highly coherent light beam (e.g., from a seed laser). The power amplifier (PA) (e.g., second optical resonator stage) increases the optical power of the light beam while preserving the beam properties. The MO can include a gas discharge chamber, an input/output optical element (e.g., optical coupler (OC)), and a spectral feature adjuster (e.g., linewidth narrowing module (LNM)). The input/output optical element and the spectral feature adjuster can surround the gas discharge chamber to form an optical resonator.

Performance of the MOPA depends critically on the alignment of the MO. Alignment of the MO can include alignment of the gas discharge chamber, alignment of the OC, and alignment of the LNM. Each of the alignments (e.g., chamber, OC, LNM, etc.) can contribute to alignment errors and variations in the MO over time. However, alignment of the MO can be time consuming and require several hours of manual maintenance (e.g., synchronized performance maintenance (SPM)). Additionally, initial alignment can be difficult (e.g., trial and error) if the chamber, OC, and LNM are drastically misaligned (e.g., no initial reference point). Further, monitoring and adjustment of the MO alignment can inhibit (e.g., block) the outputted light beam (e.g., a DUV light beam), for example, to a DUV lithographic apparatus.

Imaging light (e.g., visual laser beam) can be projected on the chamber, OC, and LNM (e.g., sequentially or simultaneously) to illuminate and direct alignment of the OC and/or the LNM along an optical axis of the chamber (e.g., first and second optical ports). Amplified spontaneous emission (ASE) from the gas discharge chamber can act as a beacon (e.g., reference point) to facilitate boresighting (e.g., laser boresighting) of the imaging light along an optical axis of the MO cavity (e.g., along the optical axis of the chamber, the OC, and the LNM). Additionally, the ASE can be used to initially align the chamber with the optical axis of the MO cavity (e.g., coarse alignment). Further, a sensing apparatus (e.g., a camera) can be used to visually investigate different object planes within the MO (e.g., chamber ports, OC aperture, LNM aperture, etc.) and quantify any alignment errors (e.g., image comparison). For example, the sensing apparatus can investigate near-field (NF) and far-field (FF) regions of imaging light on the various object planes and apply adjustments (e.g., fine alignment), for example, by beam profiling (e.g., horizontal symmetry, vertical symmetry, etc.).

Light source apparatuses and systems as discussed below can reduce alignment times (e.g., SPM) of a master oscillator, reduce alignment variations in the master oscillator over time, and monitor and dynamically control quantifiable alignment errors of the master oscillator to provide a highly coherent light beam, for example, to a DUV lithographic apparatus.

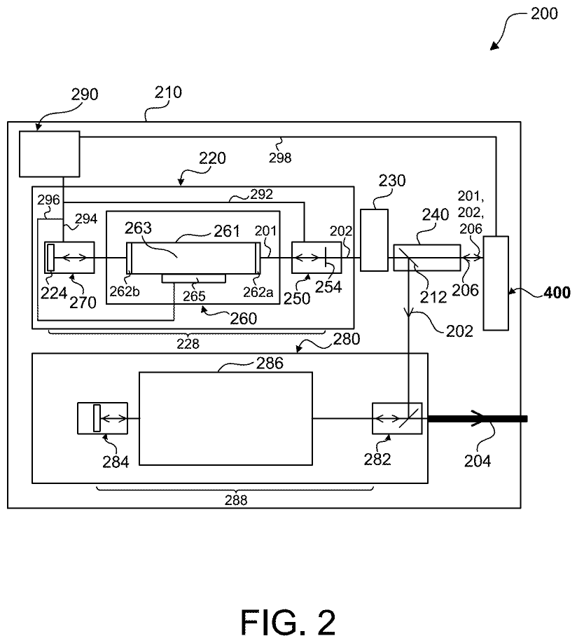

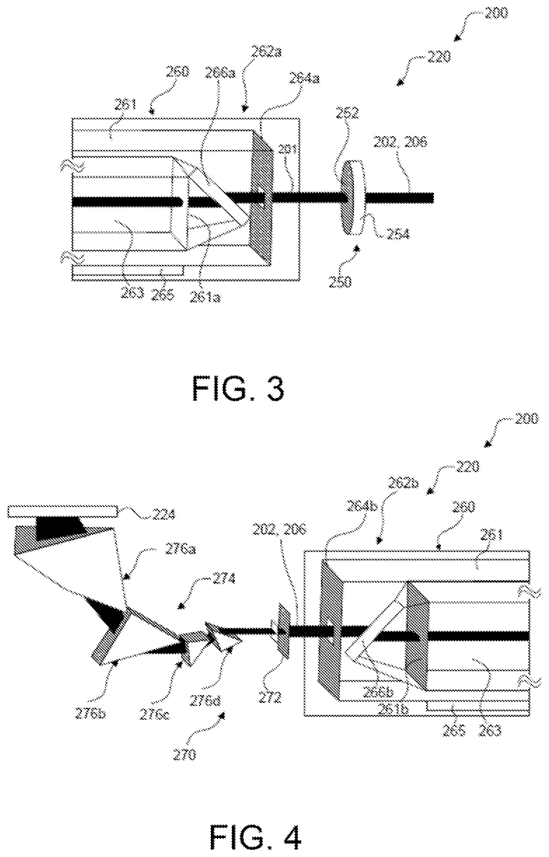

FIGS. 2-4 illustrate light source apparatus 200, according to various exemplary embodiments. FIG. 2 is a schematic top plan illustration of light source apparatus 200, according to an exemplary embodiment. FIGS. 3 and 4 are schematic partial cross-sectional illustrations of gas discharge stage 220 of light source apparatus 200 shown in FIG. 2, according to exemplary embodiments.

FIG. 2 illustrates light source apparatus 200, according to various exemplary embodiments. Light source apparatus 200 can be configured to monitor and dynamically control quantifiable alignment errors of gas discharge stage 220 (e.g., MO) and provide a highly coherent and aligned light beam (e.g., light beam 202, amplified light beam 204), for example, to a DUV lithographic apparatus (e.g., LA). Light source apparatus 200 can be further configured to reduce alignment times of gas discharge stage 220 (e.g., MO) and reduce alignment variations of gas discharge stage 220 (e.g., MO) over time. Although light source apparatus 200 is shown in FIG. 2 as a stand-alone apparatus and/or system, the embodiments of this disclosure can be used with other optical systems, such as, but not limited to, radiation source SO, lithographic apparatus LA, and/or other optical systems. In some embodiments, light source apparatus 200 can be radiation source SO in lithographic apparatus LA. For example, DUV radiation beam B can be light beam 202 and/or amplified light beam 204.

Light source apparatus 200 can be a MOPA formed by gas discharge stage 220 (e.g., MO) and power ring amplifier (PRA) stage 280 (e.g., PA). Light source apparatus 200 can include gas discharge stage 220, line analysis module (LAM) 230, master oscillator wavefront engineering box (MoWEB) 240, power ring amplifier (PRA) stage 280, and controller 290. In some embodiments, all of the above listed components can be housed in a three-dimensional (3D) frame 210. In some embodiments, 3D frame 210 can include a metal (e.g., aluminum, steel, etc.), a ceramic, and/or any other suitable rigid material.

Gas discharge stage 220 can be configured to output a highly coherent light beam (e.g., light beam 202). Gas discharge stage 220 can include first optical resonator element 254, second optical resonator element 224, input/output optical element 250 (e.g., OC), optical amplifier 260, and spectral feature adjuster 270 (e.g., LNM). In some embodiments, input/output optical element 250 can include first optical resonator element 254 and spectral feature adjuster 270 can include second optical resonator element 224. First optical resonator 228 can be defined by input/output optical element 250 (e.g., via first optical resonator element 254) and spectral feature adjuster 270 (e.g., via second optical resonator element 224). First optical resonator element 254 can be partially reflective (e.g., partial mirror) and second optical resonator element 224 can be reflective (e.g., mirror or grating) to form first optical resonator 228. First optical resonator 228 can direct light generated by optical amplifier 260 (e.g., amplified spontaneous emission (ASE) 201) into optical amplifier 260 for a fixed number of passes to form light beam 202. In some embodiments, as shown in FIG. 2, gas discharge stage 220 can output light beam 202 to PRA stage 280 as part of a MOPA arrangement.

PRA stage 280 can be configured to amplify light beam 202 from gas discharge stage 220 through a multi-pass arrangement and output amplified light beam 204. PRA stage 280 can include third optical resonator element 282, power ring amplifier (PRA) 286, and fourth optical resonator element 284. Second optical resonator 288 can be defined by third optical resonator element 282 and fourth optical resonator element 284. Third optical resonator element 282 can be partially reflective (e.g., partial beam splitter) and fourth optical resonator element 284 can be reflective (e.g., mirror or prism or beam reverser) to form second optical resonator 288. Second optical resonator 288 can direct light beam 202 from gas discharge stage 220 into PRA 286 for a fixed number of passes to form amplified light beam 204. In some embodiments, PRA stage 280 can output amplified light beam 204 to a lithographic apparatus, for example, lithographic apparatus (LA). For example, amplified light beam 204 can be EUV and/or DUV radiation beam B from radiation source SO in lithographic apparatus LA.

As shown in FIGS. 2-4, optical amplifier 260 can be optically coupled to input/output optical element 250 and spectral feature adjuster 270. Optical amplifier 260 can be configured to output ASE 201 and/or light beam 202. In some embodiments, optical amplifier 260 can utilize ASE 201 as a beacon to guide boresighting of an optical axis of chamber 261 and/or an optical axis of gas discharge stage 220 (e.g., MO cavity). Optical amplifier 260 can include chamber 261, gas discharge medium 263, and chamber adjuster 265. Gas discharge medium 263 can be disposed within chamber 261, and chamber 261 can be disposed on chamber adjuster 265.

Chamber 261 can be configured to hold gas discharge medium 263 within first and second chamber optical ports 262a, 262b. Chamber 261 can include first chamber optical port 262a and second chamber optical port 262b opposite first chamber optical port 262a. In some embodiments, first and second chamber optical ports 262a, 262b can form an optical axis of chamber 261.

As shown in FIG. 3, first chamber optical port 262a can be in optical communication with input/output optical element 250. First chamber optical port 262a can include first chamber wall 261a, first chamber window 266a, and first chamber aperture 264a. In some embodiments, as shown in FIG. 3, first chamber aperture 264a can be a rectangular opening.

As shown in FIG. 4, second chamber optical port 262b can be in optical communication with spectral feature adjuster 270. Second chamber optical port 262b can include second chamber wall 261b, second chamber window 266b, and second chamber aperture 264b. In some embodiments, as shown in FIG. 4, second chamber aperture 264b can be a rectangular opening. In some embodiments, the optical axis of chamber 261 passes through first and second chamber apertures 264a, 264b.

Gas discharge medium 263 can be configured to output ASE 201 (e.g., 193 nm) and/or light beam 202 (e.g., 193 nm). In some embodiments, gas discharge medium 263 can include a gas for excimer lasing (e.g., Ar2, Kr2, F2, Xe2, ArF, KrCl, KrF, XeBr, XeCl, XeF, etc.). For example, gas discharge medium 263 can include ArF or KrF and, upon excitation (e.g., applied voltage) from surrounding electrodes (not shown) in chamber 261, output ASE 201 (e.g., 193 nm) and/or light beam 202 (e.g., 193 nm) through first and second chamber optical ports 262a, 262b. In some embodiments, gas discharge stage 220 can include a voltage power supply (not shown) configured to apply high voltage electrical pulses across electrodes (not shown) in chamber 261.

Chamber adjuster 265 can be configured to spatially adjust (e.g., laterally, angularly, etc.) an optical axis of chamber 261 (e.g., along first and second chamber optical ports 262a, 262b). As shown in FIG. 2, chamber adjuster 265 can be coupled to chamber 261 and first and second chamber optical ports 262a, 262b. In some embodiments, chamber adjuster 265 can have six degrees of freedom (e.g., 6-axes). For example, chamber adjuster 265 can include one or more linear motor(s) and/or actuator(s) providing adjustment of the optical axis of chamber 261 in six degrees of freedom (e.g., forward/back, up/down, left/right, yaw, pitch, roll). In some embodiments, chamber adjuster 265 can adjust chamber 261 laterally and angularly to align the optical axis of chamber 261 (e.g., along first and second chamber optical ports 262a, 262b) with an optical axis of gas discharge stage 220 (e.g., MO cavity). For example, as shown in FIG. 2, the optical axis of gas discharge stage 220 (e.g., MO cavity) can be defined by the optical axis of chamber 261 (e.g., along first and second chamber optical ports 262a, 262b), input/output optical element 250 (e.g., OC aperture 252), and spectral feature adjuster 270 (e.g., LNM aperture 272).

Input/output optical element 250 can be configured to be in optical communication with first chamber optical port 262a. In some embodiments, input/output optical element 250 can be an optical coupler (OC) configured to partially reflect a light beam and form first optical resonator 228. For example, OCs have been previously described in U.S. Pat. No. 7,885,309, issued Feb. 8, 2011, which is hereby incorporated by reference in its entirety. As shown in FIG. 2, input/output optical element 250 can include first optical resonator element 254 to direct (e.g., reflect) light into optical amplifier 260 and to transmit light (e.g., light beam 202, ASE 201) from optical amplifier 260 out of gas discharge stage 220 (e.g., MO cavity).

As shown in FIG. 3, input/output optical element 250 can include OC aperture 252 and first optical resonator element 254. First optical resonator element 254 can be configured to angularly adjust (e.g., tip and/or tilt) light through OC aperture 252 in vertical and/or horizontal directions relative to chamber 261 (e.g., first chamber optical port 262a). In some embodiments, OC aperture 252 can be a rectangular opening. In some embodiments, alignment of gas discharge stage 220 can be based on alignment of first chamber aperture 264a and OC aperture 252. In some embodiments, first optical resonator element 254 can adjust input/output optical element 250 angularly (e.g., tip and/or tilt) such that reflections from input/output optical element 250 are parallel to the optical axis of gas discharge stage 220 (e.g., MO cavity). In some embodiments, first optical resonator element 254 can be an adjustable mirror (e.g., partial reflector, beam splitter, etc.) capable of angular adjustment (e.g., tip and/or tilt). In some embodiments, OC aperture 252 can be fixed and first optical resonator element 254 can be adjusted. In some embodiments, OC aperture 252 can be adjusted. For example, OC aperture 252 can be spatially adjusted in vertical and/or horizontal directions relative to chamber 261.

Spectral feature adjuster 270 (e.g., LNM) can be configured to be in optical communication with second chamber optical port 262b. In some embodiments, spectral feature adjuster 270 can be a line narrowing module (LNM) configured to provide spectral line narrowing to a light beam. For example, LNMs have been previously described in U.S. Pat. No. 8,126,027, issued Feb. 28, 2012, which is hereby incorporated by reference in its entirety.

As shown in FIG. 2, spectral feature adjuster 270 can include second optical resonator element 224 to direct (e.g., reflect) light (e.g., light beam 202, ASE 201) from optical amplifier 260 back into optical amplifier 260 toward input/output optical element 250.

As shown in FIG. 4, spectral feature adjuster 270 can include LNM aperture 272 and tilt angular modulator (TAM) 274. TAM 274 can be configured to angularly adjust light through LNM aperture 272 in vertical and/or horizontal directions relative to chamber 261 (e.g., second chamber optical port 262b). In some embodiments, LNM aperture 272 can be a rectangular opening. In some embodiments, alignment of gas discharge stage 220 can be based on alignment of second chamber aperture 264b and LNM aperture 272. In some embodiments, TAM 274 can adjust spectral feature adjuster 270 angularly (e.g., tip and/or tilt) such that reflections from spectral feature adjuster 270 are parallel to the optical axis of gas discharge stage 220 (e.g., MO cavity). In some embodiments, TAM 274 can include adjustable mirrors (e.g., partial reflector, beam splitter, etc.) and/or adjustable prisms capable of angular adjustment (e.g., tip and/or tilt). In some embodiments, LNM aperture 272 can be fixed and TAM 274 can be adjusted. In some embodiments, LNM aperture 272 can be adjusted. For example, LNM aperture 272 can be spatially adjusted in vertical and/or horizontal directions relative to chamber 261.

In some embodiments, the adjustable mirrors (e.g., partial reflector, beam splitter, etc.) and/or adjustable prisms of TAM 274 can include a plurality of prisms 276a-d. Prisms 276a-d can be actuated to manipulate an incident angle of incoming light on second optical resonator element 224, which can serve to select a narrow band of wavelength to reflect back along the optical path. In some embodiments, prism 276a can be fitted with a stepper motor with limited step resolution and can be used for coarse wavelength control. Prism 276b may be actuated using a piezoelectric transducer (PZT) actuator, which provides for improved resolution and bandwidth in comparison to prism 276a. In operation, controller 290 can use prisms 276a, 276b in a dual-stage configuration.

LAM 230 can be configured to monitor a line center (e.g., center wavelength) of a light beam (e.g., light beam 202, imaging light 206). LAM 230 can be further configured to monitor an energy of a light beam (e.g., ASE 201, light beam 202, imaging light 206) for metrology wavelength measurements. For example, LAMs have been previously described in U.S. Pat. No. 7,885,309, issued Feb. 8, 2011, which is hereby incorporated by reference in its entirety.

As shown in FIG. 2, LAM 230 can be optically coupled to gas discharge stage 220 and/or MoWEB 240. In some embodiments, LAM 230 can be disposed between gas discharge stage 220 and MoWEB 240. For example, as shown in FIG. 2, LAM 230 can be optically coupled directly to MoWEB 240 and optically coupled to gas discharge stage 220. In some embodiments, as shown in FIG. 2, beamsplitter 212 can be configured to direct ASE 201 and/or light beam 202 toward PRA stage 280, and direct ASE 201 and/or light beam 202 toward an imaging apparatus. In some embodiments, as shown in FIG. 2, beamsplitter 212 can be disposed in MoWEB 240.

MoWEB 240 can be configured to provide beam shaping to a light beam (e.g., light beam 202, imaging light 206). MoWEB 240 can be further configured to monitor forward and/or backward propagation of a light beam (e.g., ASE 201, light beam 202, imaging light 206). For example, MoWEBs have been previously described in U.S. Pat. No. 7,885,309, issued Feb. 8, 2011, which is hereby incorporated by reference in its entirety. As shown in FIG. 2, MoWEB 240 can be optically coupled to LAM 230. In some embodiments, LAM 230, MoWEB 240, and/or imaging apparatus can be optically coupled to gas discharge stage 220 via a single optical arrangement.

Controller 290 can be configured to be in communication with input/output optical element 250, chamber adjuster 265, and/or spectral feature adjuster 270. In some embodiments, controller 290 can be configured to provide first signal 292 to input/output optical element 250, second signal 294 to spectral feature adjuster 270, and third signal 296 to chamber adjuster 265. In some embodiments, controller 290 can be configured to provide a signal (e.g., first signal 292 and/or second signal 294) to input/output optical element 250 and/or spectral feature adjuster 270 and adjust input/output optical element 250 (e.g., adjust first optical resonator element 254) and/or spectral feature adjuster 270 (e.g., adjust TAM 274) based on an output (e.g., two-dimensional (2D) image comparison) from imaging apparatus 400.

In some embodiments, first optical resonator element 254, chamber adjuster 265, and/or TAM 274 can be in physical and/or electronic communication with controller 290 (e.g., first signal 292, second signal 294, and/or third signal 296). For example, first optical resonator element 254, chamber adjuster 265, and/or TAM 274 can be adjusted (e.g., laterally and/or angularly) by controller 290 to align the optical axis of chamber 261 (e.g., along first and second chamber optical ports 262a, 262b) with the optical axis of gas discharge stage 220 (e.g., MO cavity) defined by input/output optical element 250 (e.g., OC aperture 252) and spectral feature adjuster 270 (e.g., LNM aperture 272).

Typically, the tuning takes place in the LNM. A typical technique used for line narrowing and tuning of lasers is to provide a window at the back of the laser's discharge cavity through which a portion of the laser beam passes into the LNM. There, the portion of the beam is expanded with a prism beam expander and directed to a grating which reflects a narrow selected portion of the laser's broader spectrum back into the discharge chamber where it is amplified. The laser is typically tuned by changing the angle at which the beam illuminates the grating using an actuator such as, for example, a piezoelectric actuator.

Thus, the primary wavelength actuator is the LNM. As discussed above, the LNM may include the plurality of prisms 276a-d and the second optical resonator element 224 (e.g., a grating). The plurality of prisms 276a-d may be actuated to manipulate an incoming light's incident angle on the second optical resonator element 224, which serves to select a narrow band of wavelength to reflect back along the optical path. In some embodiments, a magnitude of the incident angle may control the wavelength selected.

In some embodiments, to control the magnitude of the incident angle, and consequently, the wavelength selected, the plurality of prisms 276a-d may be used to adjust the final incident angle. For example, prism 276a may have more control over the final incident angle than the 276b. That is, in some embodiments, the controller 290 uses prisms 276a, 276b in a dual-stage configuration, with prism 276a being used for large jumps and to desaturate prism 276b, which is used for finer changes to the final incident angle. Controlling prisms 276a, 276b is of particular important for MFI operations, which require more than regulation around a setpoint, and instead, require precise tracking of a sinusoid at Nyquist frequency in addition to precise control of the center point of the sinusoid (i.e., the central wavelength). There are processes for controlling the central wavelength for imaging operations, such as MFI operations.

Multi-focal imaging operations may include a two-color mode. In the two-color mode, a wavelength target may alternate between two known setpoints within a burst (e.g., every pulse), and the PZT may be used in order to track the fast-changing target. As set forth above, for some applications it is beneficial to be able to one or more pulses having one wavelength and then be able to switch to generating one or more pulses having a different wavelength.

In some embodiments, the processes provide for moving an actuator controlling movement of prism 276b during a burst. That is, the processes provide for an intra-burst solution for addressing a change to the center wavelength. According to another aspect, a dynamic model of the actuator is used to compute an optimal control waveform for actuating the actuator to minimize the difference between actual wavelength and wavelength targets.

In some embodiments, a dither waveform (or sequence) can be combined with an offset for moving an actuator for prism 276b. For example, the dither waveform may be an applied form of noise used to randomize quantization. The offset can be updated at an end-of-burst (EOB) and/or at a set pulse interval. In some embodiments, the EOB update can move the actuator for prism 276b to zero out the estimated center wavelength drift obtained by averaging the wavelength measurements of the entire burst. In some embodiments, the interval updates can be based on an estimation process.

The optimal control waveform can be computed using any one of several methods. For example, the optimal control waveform may be computed using dynamic programming. This method is well adapted for dealing with complex models that contain nonlinear dynamics. If an actuator model is adopted that has strong nonlinear dynamics, then dynamic programming may be used to generate the optimal control signal for given wavelength targets. Dynamic programming does, however, present the challenge that it requires significant computational resources which may not be implementable in real-time. To overcome this a data storage device such as a pre-populated look-up-table or a pre-programmed field programmable gate array (FPGA) may be used which contains optimal control parameters for at least some of the different repetition rates at which the source may be operated.

As another example, the optimal control waveform may be determined using model inversion feedforward control. This method relies on the actuator dynamic model to construct a digital filter that inverts the actuator dynamic. By passing the desired waveform for the desired actuator trajectory through this filter, an optimal control waveform can be generated in real time to achieve zero steady state error tracking.

As another example, an optimal solution to achieve two separate wavelengths in a stable manner is accomplished using a learning algorithm to guarantee error convergence over several iterations of learning. Embodiments of the systems and methods disclosed herein can potentially achieve two separate wavelengths separated by 1000 fm with a separation error below 20 fm.

According to another aspect, the optimal control waveform may be fed to the actuator at a very high rate by using a FPGA.

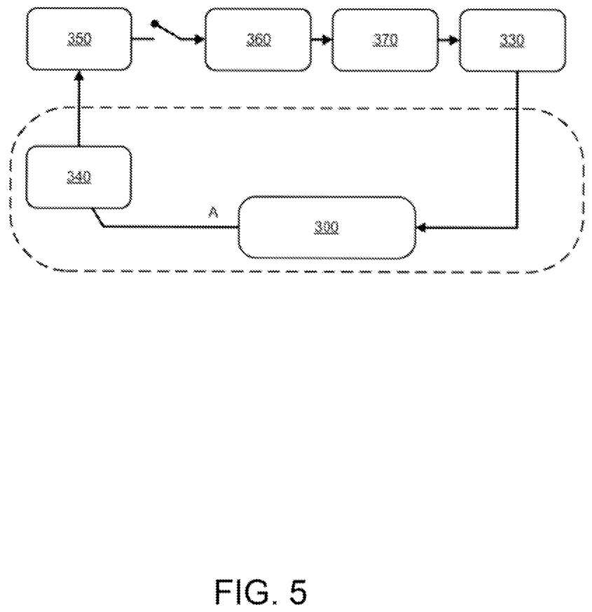

The control system may include a combination of feed-forward control and iterative learning control (ILC). As shown in FIG. 5, a feed-forward control signal A is computed offline by ILC module 300 using a wavelength measurement from streaming data acquisition unit 330 and an ILC correction/update law as will be described below. A bandwidth wavelength control module (BWCM) 340 uses the feed-forward control signal A to update pre-defined data in a data storage unit such as an FPGA included in the BWCM 340. The BWCM 340 then actuates a PZT 350 at, for example, 60 kHz when the laser is pulsing. The wavelength of the laser radiation is measured by a line center (center wavelength) analysis module (LAM) 360 and fire control platform or processor (FCP) 370, and a wavelength measurement is collected into data acquisition unit 330 at 6 kHz.

It will be appreciated that the system shown in FIG. 5 may be configured to encompass multiple frequency regimes. The area inside the broken box denotes processes that may occur essentially offline. The PZT 350 may be driven at about 60 kHz. Wavelength data may be acquired at about 6 kHz.

In order to account for constraints on the change of PZT voltage, quadratic programming with constraints may be used to help find the optimal feed-forward signal within the feasible region of operation. Quadratic programming is a technique that finds the optimal solution to a given quadratic cost function with constraints mathematically.

The standard QP solver can solve a problem with the following structure:

$${min}_{X} ( \frac{1}{2} {X}^{T} HX + {f}^{T} X \}$$

$$s . t . LX \leq b$$

where X is the design parameter that can be freely chosen except that it has to satisfy LX≤b. In other words, the QP solver finds the optimal X that minimizes the cost function within a feasible region defined by LX≤b.

In the application being described here, the objective is to find the feed-forward control that satisfies the actuator constraints while minimizing the error between actuator position and the desired control waveform. The PZT dynamic can be expressed in the following state-space form:

x(k+1)=Ax(k)+Bu(k)

y(k+1)=Cx(k+1)

where A, B, C are the state, input, and output matrices, respectively, that describe the PZT dynamics; x is the state vector, u is the input vector, and y is the output from PZT.
Substituting the above dynamic model, the original cost function can be rewritten as

$${min}_{U} \{ \frac{1}{2} {U}^{T} {P}^{T} QPU - {R}^{T} QPU )$$

$$s . t . DU \leq l$$

This fits into the standard QP form where

and P describes the PZT input-output dynamics, Q is the weighting function, R denotes the

H=P^{T}QP

f=−P^{T}QR

X=U

L=D

b=l

desired control waveform, D represents the actuator constraints, and l is the threshold on the actuator constraints.

ILC is a method of tracking control for systems that work in a repetitive mode. In each of these tasks the system is required to perform the same action over and over again with high precision. This action is represented by the objective of accurately tracking a chosen reference signal on a finite time interval. Repetition allows the system to improve tracking accuracy from repetition to repetition, in effect learning the required input needed to track the reference exactly. The learning process uses information from previous repetitions to improve the control signal ultimately enabling a suitable control action can be found iteratively. The internal model principle yields conditions under which perfect tracking can be achieved but the design of the control algorithm still leaves many decisions to be made to suit the application.

According to another aspect, ILC control can be described by the following equations:

Uₖ=Uₖ₋₁+LEₖ₋₁

where Uₖ is the feedforward control signal used at kth iteration, L is the learning function that dictates the convergence of the ILC algorithm, and Eₖ is the error at kth iteration

The stability and convergence property of the ILC control can be derived by combining the ILC control law with the dynamic model of the system as

Eₖ=(I−PL)Eₖ₋₁

where P is the matrix that describes the input-output relation of the system, and I is the identity matrix. Stability is guaranteed if the absolute value of all the eigenvalues of (I−PL) is smaller than 1. The convergence rate is also determined by the matrix (I−PL). If (I−PL)=0 then the error would converge to 0 after one iteration.

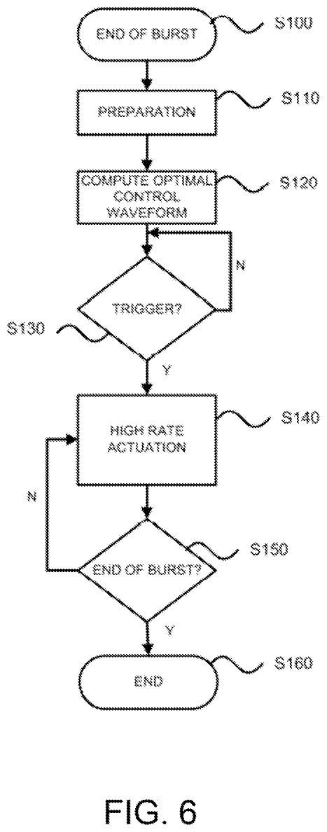

FIG. 6 is a flowchart showing a method of controlling a radiation source according to one aspect of an embodiment. In a step S100 a prior burst of pulses has ended. In step S110 the actuator is prepared by pre-positioning it to a position which is between the position it should be in to produce pulses having a first repetition rate/first frequency and the position it should be to produce pulses having a second repetition rate/second frequency. In a step S120 an optimal control waveform is computed using one or more of the techniques described above. In a step S130 it is determined whether a new burst has been triggered. If “yes” a new burst has been triggered, then in a step S140 the parameters for operation at a commanded repetition rate and frequency are relayed to the source using, for example, an FPGA. In step S150 it is determined whether the current burst has ended. If the current burst has not ended, then step S140 is repeated. If the burst has ended, then the process ends at step S160.

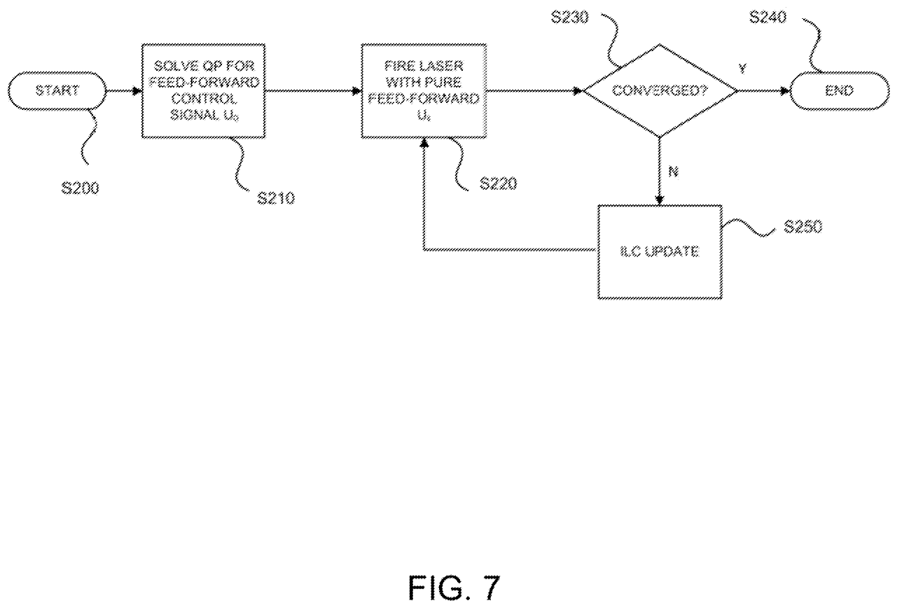

FIG. 7 shows a method performed by the ILC for computing its update law with an initial QP feedforward control signal. In a step S210 quadratic programming is used to develop an initial feedforward control signal. In a step S220 the feedforward control signal as used to fire the laser. In a step S230, it is determined whether the error in the feed-forward signal has converged. If the error has not converged, then in step S250 iterative learning is used to update the control signal. The new control signal is then used to fire the laser in step S220. If the error has converged, then the process ends as in step S240.

As mentioned, typically an MFI algorithm presumes the laser will be operated in MFI mode only at (or substantially near) 6 kHz, and so calibrates and optimizes the base waveform for the PZT dither for performance at this single operation point. Because the algorithm expects the repetition rate for each successive field to be similar to that for the previous field, the inclusion of lower repetition rate fields, for example, at the edge of a wafer or even at the center of a wafer fields introduces a long-lasting corruption into the learned compensation that will cause wafer scrap or cause a dose controller to be unable to come to a solution, halting production.

To address this issue, rather than use a single calibrated base waveform, according to an aspect of an embodiment, the parameters (e.g., amplitude, phase) of the waveform to be used are determined based on repetition rate or a range which includes the repetition rate. The waveform may be computed on the fly on the basis of the repetition rate. The waveform may be binned, that is, selected from a memory such as a lookup table loaded to the firmware depending on which range of several ranges includes the currently-commanded demanded repetition rate. The waveform may be determined using a field programmable gate array. This enables extending the usable repetition rate range for MFI.

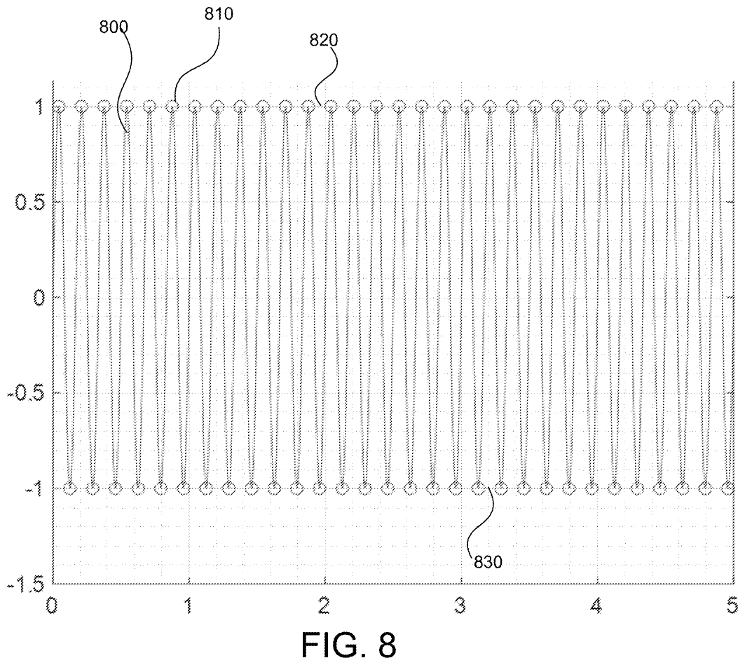

FIG. 8 shows a waveform 800 to be applied to the actuator to achieve alternating two-color pulses, that is, a burst including first pulses having one color alternating with second pulses having a second color. The X-axis shows time in milliseconds. The Y-axis shows amplitude of the waveform 800 in arbitrary units. The circles 810 represent individual pulses or shots from the laser. The upper horizontal line 820 indicates the target position for the actuator when a pulse having a first color is supposed to occur. The lower horizontal line 830 indicates the target position for the actuator when a pulse having a second color occurs. In the ideal condition shown in FIG. 8, the minima and maxima of the waveform 800 coincide with the pulses at the target levels.

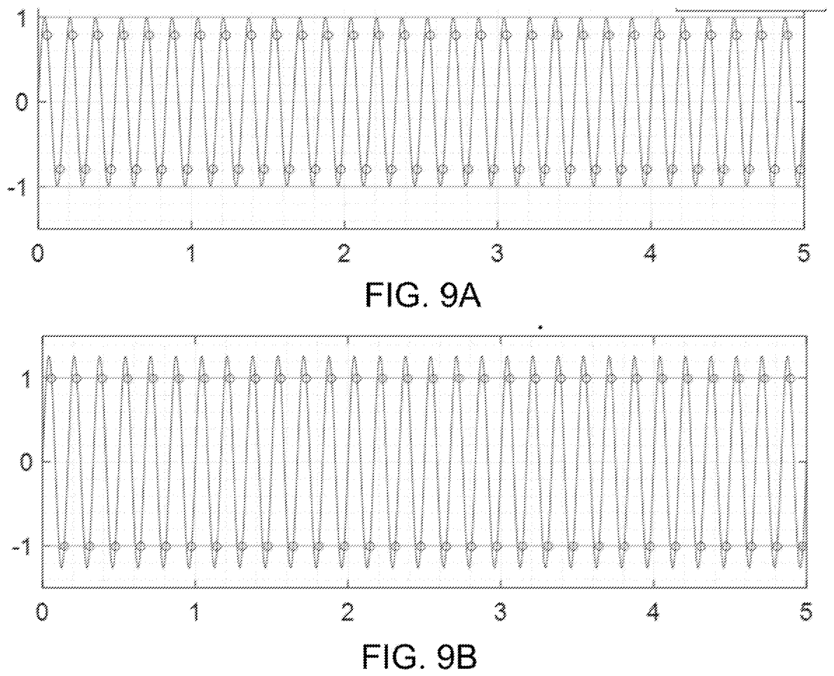

FIG. 9A shows a condition in which use of a waveform which may provide satisfactory results at a particular repetition rate causes suboptimal operation at another repetition rate. Here, the suboptimal operation is a constant phase offset which results in pulses occurring after the waveform has assumed its target value. In such circumstances a waveform having an increased maximum amplitude absolute value is commanded as shown in FIG. 9B so that the waveform is at its target value when the pulses occur.

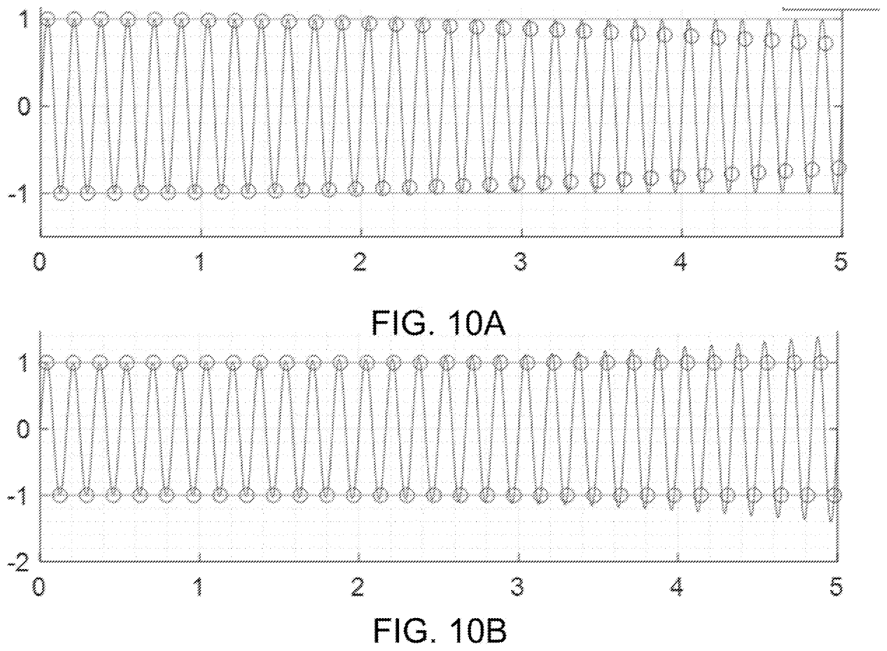

FIG. 10A shows another example of a condition in which use of a waveform which may provide satisfactory results at a particular repetition rate causes suboptimal operation at another repetition rate. Here, the suboptimal operation is a variable phase offset which again results in pulses occurring after the waveform has assumed its target value in later pulses in the sequence (burst). In such circumstances a waveform having an amplitude with a maximum absolute value that increases with time is commanded as shown in FIG. 10B so that the waveform is at its target value when the pulses occur.

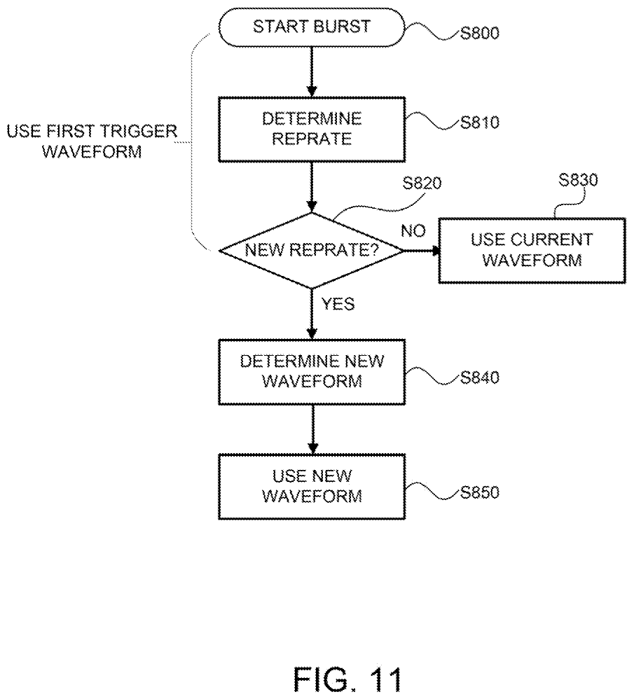

FIG. 11 is a flowchart showing a process for providing a waveform suitable for a current repetition rate. A burst starts at a step S800. In a step S810 the current repetition rate is determined (reprate in the figure) and in a step S820 it is determined whether the current repetition rate is different from the repetition rate used in an immediately prior burst. If the repetition rate is not new, then, in a step S830, the current waveform remains in use. If the repetition rate is new, then, in a step S840, a new waveform (i.e., one or more parameters for a new waveform) is determined and in step S850 the new waveform is employed. As noted, during performance of the steps up to the determination of whether a new repetition rate is being used, a transitional or “first trigger” waveform may be used which may be, for example, the repetition rate from the previous burst or a generic default waveform which is known to operate satisfactorily during the initial pulses of a burst. It is possible that the new waveform will be the same as the existing waveform if the same waveform is optimal for the two different repetition rates. As noted, according to another aspect of an embodiment, because technical issues arising from variation in repetition rate tend to become more pronounced in the later pulses of a given burst, a first trigger waveform may be used for a predetermined number of initial pulses in a burst, e.g., a “grace period” of the first pulses of each burst but enough pulses to accurately determine the repetition rate. This may be, for example, two or three pulses. The first trigger waveform may be, for example, a default waveform. The first trigger waveform may be the waveform used for a latter portion of the previous burst. The first trigger waveform would be used until the most appropriate waveform can be determined.

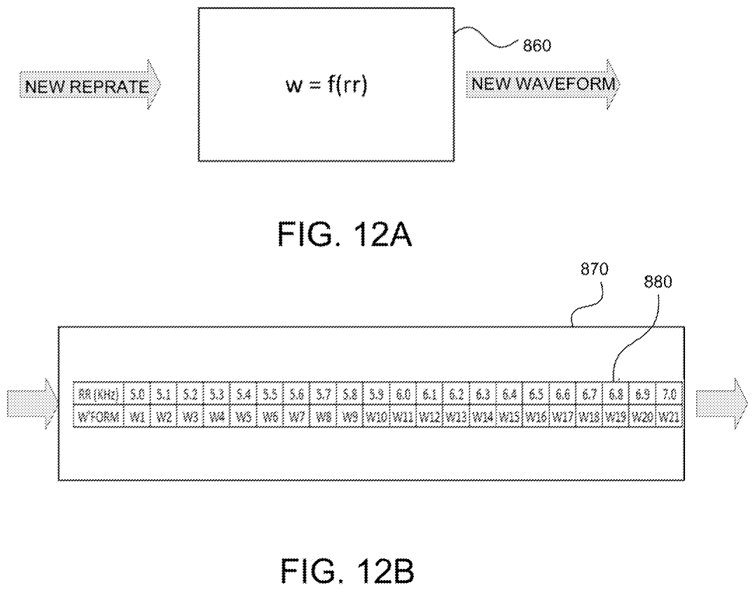

FIG. 12A is a conceptual diagram of system 860 for selecting a new waveform based on the current repetition rate. In the system shown in FIG. 12A, the new repetition rate is used as an input variable to a function which computes a waveform as a function of repetition rate. This function may be determined heuristically for given system. Alternatively, as shown in FIG. 12B, the system 870 for selecting an optimal waveform based on repetition rate can include a look-up-table 880 which lists parameters for waveforms W1, W2, and so forth from various repetition rates binned, for example, in tenths of kilohertz. The waveforms may be parameterized by amplitude as shown in one example above, change in amplitude with time, also shown as an example above, phase, or frequency. The system may also be implemented as a field programmable gate array. In FIG. 12B of the petition rates range from 5 kHz to 7 kHz with binning, as mentioned, in 0.10 kHz bins. It will be appreciated by one of ordinary skill the art, however, that a different range may be used, a different center point may be used, and different bin sizes may be used.

As regards the ILC algorithm, according to another aspect of an embodiment, the learned correction can also be binned by repetition rate. Methods analogous to those described above could be used to bridge the gap between the first pulse of a burst and the pulse at which the repetition rate is determined, i.e., at which the repetition rate estimate is latched.

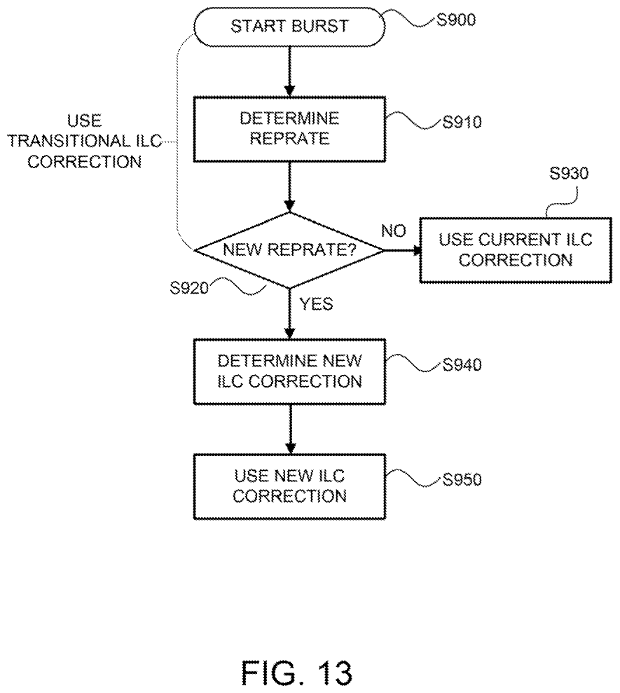

FIG. 13 is a flowchart showing a process for providing an ILC correction suitable for a current repetition rate. A burst starts at a step S900. In a step S910 the current repetition rate is determined (reprate in the figure) and in a step S920 it is determined whether the current repetition rate is different from the repetition rate used in an immediately prior burst. If the repetition rate is not new, then, in a step S930, the current ILC correction remains in use. If the repetition rate is new, however, then, in a step S940, a new ILC correction is determined and in step S950 the new ILC correction is employed. As noted, for the steps up to the determination of whether a new repetition rate is being used, a transitional ILC correction may be used which may be, for example, the ILC correction from the previous burst or a generic default ILC correction which is known to by satisfactory performance at least during the initial pulses of a burst. It is possible that the new ILC correction will be the same as the existing ILC correction if the same ILC correction is optimal for the two different repetition rates.

As noted, according to another aspect of an embodiment, because technical issues arising from variation in repetition rate tend to become more pronounced in the later pulses of a given burst, a transitional ILC correction may be used for a predetermined number of initial pulses in a burst, e.g., the first few pulses of each burst but enough pulses to accurately determine the repetition rate. The transitional ILC correction may be, for example, a default ILC correction. The transitional ILC correction may be the ILC correction used for a latter portion of the previous burst. The transitional ILC correction would be used until the most appropriate ILC correction can be determined.

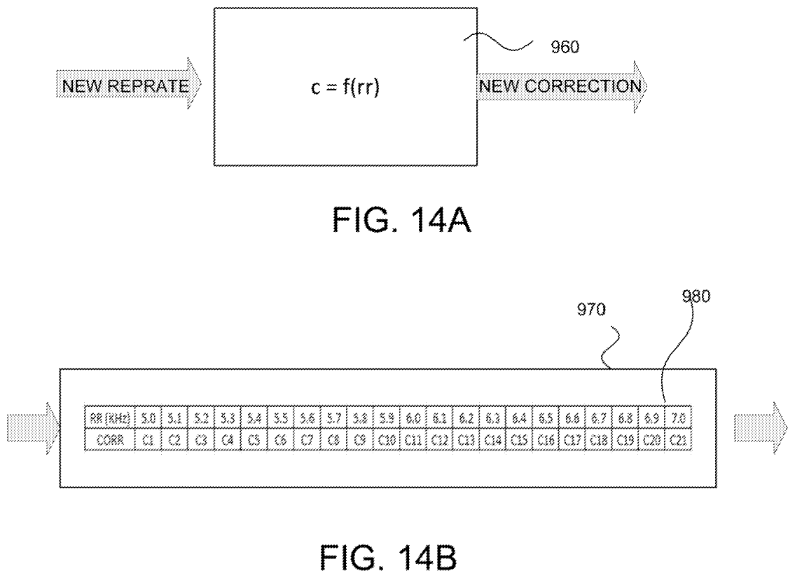

FIG. 14A is a conceptual diagram of system 960 for selecting a new ILC correction based on the current repetition rate. In the system shown in FIG. 14A, the new repetition rate is used as a parameter in a function which computes an ILC correction as a function of repetition rate. This function may be determined heuristically for given system. Alternatively, as shown in FIG. 14B, the system 970 for selecting an optimal ILC correction based on repetition rate can include a look-up-table 980 which lists parameters for ILC corrections C1, C2, and so forth from various repetition rates binned, for example, in tenths of kilohertz. The system 970 may also be implemented as a field programmable gate array. In FIG. 14B of the repetition rates range from 5 kHz to 7 kHz with binning, as mentioned, in 0.10 kHz bins. It will be appreciated by one of ordinary skill the art, however, that a different range may be used, a different center point may be used, and different bin sizes may be used.

According to an aspect of an embodiment, the system starts playing back a “first trigger” waveform on the first trigger (equivalently first pulse) of each burst. The system, of course, does not identify the repetition rate of the new burst until the second trigger of the new burst. Then the system identifies the repetition rate of the new burst as the reciprocal of the time between the triggers. At this point the system can (1) continue playing back the then-current waveform if it determines that the then-current waveform yields acceptable performance for the determined repetition rate or (2) transition to a new waveform that will yield acceptable performance for the determined repetition rate if it determines that the then-current waveform does not determine acceptable performance for the determined repetition rate.

In other words,
1. Burst x, pulse 1→actuation per first trigger waveform
2. Burst x, pulse 2→1) identify repetition rate repRate(x); (2) select waveform X based on determined repetition rate; and 3) start actuation per selected waveform X
3. Burst x+1, pulse 1→actuation per first trigger waveform
4. Burst x+1, pulse 2→1) identify repetition rate repRate(x+1); (2) select waveform Y based on determined repetition rate; and 3) start actuation per selected waveform Y

Waveform Y will be the same as waveform X if repRate(x) is the same as (or close enough to) repRate(x+1). In this context, “close enough to” means that the waveform X yields acceptable performance at both repRate(x) and repRate(x+1).

The first trigger waveform can be any one of several waveforms. For example, the first trigger waveform may be simply a constant level. The first trigger waveform may be a default waveform which may be selected as one most likely to be determined for use as waveform Y. The first trigger waveform may be waveform X, that is, the waveform from the preceding burst. These are simply examples.

According to an aspect of an embodiment, the system does not make assumption on the repetition rate. It instead determines the correct waveform to use only after the repetition rate has been identified.

According to another aspect of an embodiment, the apparatus and method may include provision for a controlled transition from between waveforms, e.g., (1) from a waveform X of Burst x to a first trigger waveform for Burst x+1 and (2) from a first trigger waveform to the waveform Y determined for Burst x+1, once the repetition rate for Burst x+1 has been determined.

This transition management can be accomplished by any one of several techniques. For example, the transition may be handled by using a cross-fade technique, in which a current waveform is ramped out while a new waveform is ramped in. In other words, a negative gain change on the outgoing waveform causes the fade-out of the outgoing waveform. At the same time a positive gain change on the new waveform causes the fade-in of the new waveform. The transition may be handled by detection of when the outgoing waveform crosses zero and swapping in the new waveform starting with one of its zero crossings in the same direction. When the amplitude does not vary the transition may be handled by switching at a local minimum or maximum where the time derivative is a minimum. These are simply examples. Of course, as mentioned, the transition handling must be fast enough that it does not extend past the “grace period”, i.e., into the time that performance during the new burst begins to degrade unacceptably from use of the first trigger waveform.

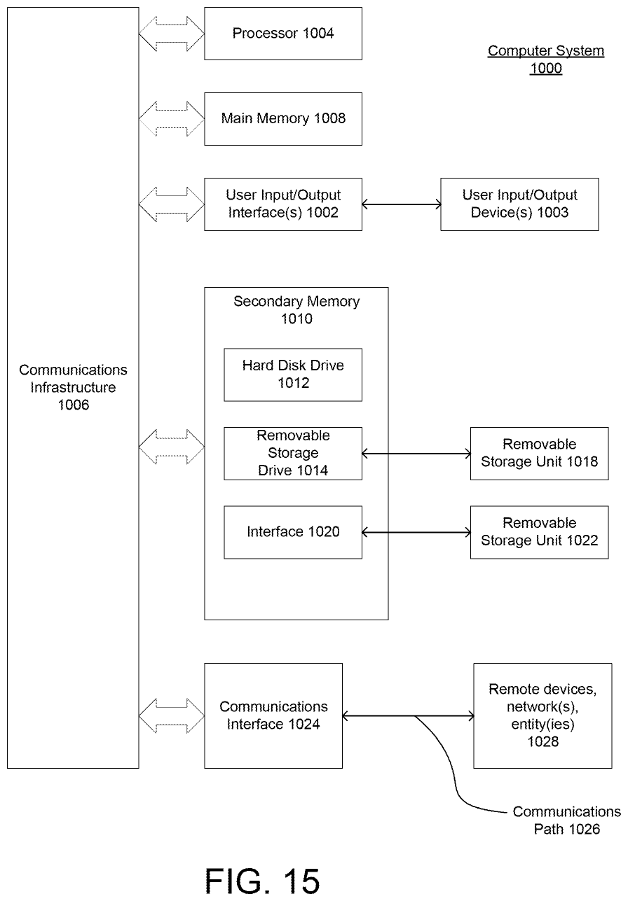

As shown in FIG. 15, various embodiments and components therein can be implemented, for example, using one or more well-known computer systems, such as, for example, the example embodiments, systems, and/or devices shown in the figures or otherwise discussed. Computer system 1000 can be any well-known computer capable of performing the functions described herein.

Computer system 1000 includes one or more processors (also called central processing units, or CPUs), such as a processor 1004. Processor 1004 is connected to a communication infrastructure or bus 1006.

One or more processors 1004 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 also includes user input/output device(s) 1003, such as monitors, keyboards, pointing devices, etc., that communicate with communication infrastructure 1006 through user input/output interface(s) 1002.

Computer system 1000 also includes a main or primary memory 1008, such as random access memory (RAM). Main memory 1008 may include one or more levels of cache. Main memory 1008 has stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 includes a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 reads from and/or writes to removable storage unit 1018 in a well-known manner.

According to an example embodiment, secondary memory 1010 may include other means, instrumentalities or other approaches for allowing computer programs and/or other instructions and/or data to be accessed by computer system 1000. Such means, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 enables computer system 1000 to communicate and interact with any combination of remote devices, remote networks, remote entities, etc. (individually and collectively referenced by reference number 1028). For example, communication interface 1024 may allow computer system 1000 to communicate with remote devices 1028 over communications path 1026, which may be wired and/or wireless, and which may include any combination of LANs, WANs, the Internet, etc. Control logic and/or data may be transmitted to and from computer system 1000 via communications path 1026.

In an embodiment, a non-transitory, tangible apparatus or article of manufacture comprising a non-transitory, tangible computer useable or readable medium having control logic (software) stored thereon is also referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 15. In particular, embodiments may operate with software, hardware, and/or operating system implementations other than those described herein.

Although specific reference may have been made above to the use of embodiments in the context of optical lithography, it will be appreciated that embodiments may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure, or a combination thereof. The patterning device is moved out of the resist leaving a pattern in it after the resist is cured.

It is to be understood that the phraseology or terminology herein is for the purpose of description and not of limitation, such that the terminology or phraseology of the present specification is to be interpreted by those skilled in relevant art(s) in light of the teachings herein.

The term “substrate” as used herein describes a material onto which material layers are added. In some embodiments, the substrate itself may be patterned and materials added on top of it may also be patterned or may remain without patterning.

The following examples are illustrative, but not limiting, of the embodiments of this disclosure. Other suitable modifications and adaptations of the variety of conditions and parameters normally encountered in the field, and which would be apparent to those skilled in the relevant art(s), are within the spirit and scope of the disclosure.

Although specific reference may be made in this text to the use of the apparatus and/or system in the manufacture of ICs, it should be explicitly understood that such an apparatus and/or system has many other possible applications. For example, it can be employed in the manufacture of integrated optical systems, guidance and detection patterns for magnetic domain memories, LCD panels, thin-film magnetic heads, etc. The skilled artisan will appreciate that, in the context of such alternative applications, any use of the terms “reticle,” “wafer,” or “die” in this text should be considered as being replaced by the more general terms “mask,” “substrate,” and “target portion,” respectively.

While specific embodiments have been described above, it will be appreciated that the embodiments may be practiced otherwise than as described. The description is not intended to limit the scope of the claims.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the embodiments. Therefore, such adaptations and modifications are intended to be within the meaning and range of equivalents of the disclosed embodiments, based on the teaching and guidance presented herein.

The breadth and scope of the embodiments should not be limited by any of the above-described exemplary embodiments but should be defined only in accordance with the following claims and their equivalents.

The embodiments can be further described using the following clauses:

1. A laser system comprising:
a trigger circuit for firing the laser system in at least two bursts, a first burst including a plurality of first burst pulses fired at a first repetition rate and a second burst including a plurality of second burst pulses fired at a second repetition rate;
a wavelength control device adapted to control a respective wavelength of each of the first burst pulses in response to a first applied waveform and of each of the second burst pulses in response to a second applied waveform; and
a comparator for performing a comparison between the second repetition rate and the first repetition rate and for determining one or more parameters of the second applied waveform at least partially on the basis of the comparison.

2. A laser system of clause 1 wherein the comparator determines to use a second applied waveform different from the first applied waveform if the second repetition rate is different from the first repetition rate.

3. A laser system of clause 1 wherein the comparator determines to use a second applied waveform the same as the first applied waveform if the second repetition rate is the same as the first repetition rate.

4. A laser system of clause 3 wherein the comparator computes one or more parameters for the second applied waveform using the second repetition rate as an input.

5. A laser system of clause 3 wherein the comparator comprises a field programmable gate array that determines one or more parameters for the second applied waveform based at least in part on the second repetition rate.

6. A laser system of clause 3 wherein the comparator comprises a memory having a look-up table and wherein the look-up table returns one or more parameters for the second applied waveform based on the second repetition rate.

7. A laser system of clause 6 wherein the one or more parameters include a magnitude of an amplitude of the second applied waveform.

8. A laser system of clause 6 wherein the one or more parameters include a time variation of a magnitude of an amplitude of the second applied waveform.

9. A laser system of clause 6 wherein the one or more parameters include a correction to a feedback algorithm for the second applied waveform.

10. A laser system of clause 9 wherein the feedback algorithm is an iterative learning control algorithm.

11. A laser system of clause 9 wherein the comparator applies the second applied waveform to the second burst after a plurality of trigger pulses in the second burst has been used to compute the second repetition rate.

12. A laser system of clause 11 wherein the comparator applies the second applied waveform to the second burst before the third pulse in the second burst has been used to compute the second repetition rate.

13. A laser system of clause 9 wherein the comparator applies a first trigger waveform applied during the first burst to the second burst after the plurality of trigger pulses in the second burst has been used to compute the second repetition rate.

14. A laser system of clause 13 wherein the comparator applies the first applied waveform as the first trigger waveform.

15. A laser system of clause 13 wherein the comparator applies a default waveform as the first trigger waveform.

16. A laser system of clause 13 wherein the comparator applies a constant level as the first trigger waveform.

17. A laser system of clause 13 further comprising a transition management unit for managing a transition between the first trigger waveform and the second applied waveform.

18. A laser system of clause 17 wherein the transition management unit manages the transition between the first trigger waveform and the second applied waveform by cross fading the first trigger waveform and the second applied waveform.

19. A laser system of clause 17 wherein the transition management unit manages the transition between the first trigger waveform and the second applied waveform by switching from the first trigger waveform to the second applied waveform at a zero crossing of the first trigger waveform.

20. A laser system of clause 17 wherein the transition management unit manages the transition between the first trigger waveform and the second applied waveform by switching from the first trigger waveform to the second applied waveform at a local maximum or minim of the first trigger waveform.

21. A method of controlling a laser system, the method comprising:
firing the laser system in a first burst including a plurality of first burst pulses fired at a first repetition rate;
initiating firing the laser system in a second burst including a plurality of second burst pulses while determining a second repetition rate at which the second burst pulses are fired;
using the second repetition rate to determine one or more parameters for a second burst waveform for an actuator determining wavelengths of the second burst pulses; and
applying the second burst waveform to the actuator.

22. A method of clause 21 wherein using the second repetition rate to determine one or more parameters for a second burst waveform comprises determining one or more parameters for the second burst waveform different from one or more parameters of a first burst waveform.

23. A method of clause 21 wherein using the second repetition rate to determine one or more parameters for a second burst waveform comprises determining parameters for the second burst waveform which are the same as the parameters of a first burst waveform.

24. A method of clause 21 wherein using the second repetition rate to determine one or more parameters for a second burst waveform for an actuator determining wavelengths of the second burst pulses comprises computing parameters for the second burst waveform using the second repetition rate as an input.

25. A method of clause 21 wherein using the second repetition rate to determine one or more parameters for a second burst waveform for an actuator determining wavelengths of the second burst pulses comprises using the second repetition rate as an input to a field programmable gate array to determine parameters for the second burst waveform.

26. A method of clause 21 wherein using the second repetition rate to determine one or more parameters for a second burst waveform for an actuator determining wavelengths of the second burst pulses comprises using the second repetition rate to look up parameters for the second burst waveform in a look-up table.

27. A method of clause 21 wherein the one more parameters include a magnitude of an amplitude of the second burst waveform.

28. A method of clause 21 wherein the one or more parameters include a time variation of a magnitude of an amplitude of the second burst waveform.

29. A method of clause 21 wherein the one or more parameters include a correction to a feedback algorithm for the second burst waveform.

30. A method of clause 29 wherein the feedback algorithm is an iterative learning control algorithm.

31. A method of clause 21 further comprising using a plurality of first trigger pulses in the second burst to compute the second repetition rate before using the second repetition rate to determine one or more parameters for a second burst waveform for an actuator determining wavelengths of the second burst pulses.

32. A method of clause 31 further comprising applying a first trigger waveform to the second burst during the plurality of first trigger pulses in the second burst used to compute the second repetition rate.

33. A method of clause 32 wherein the applying a first trigger waveform comprises applying the first burst waveform.

34. A method of clause 32 wherein applying a first trigger waveform comprises applying a default waveform.

35. A method of clause 32 wherein applying a first trigger waveform comprises applying a first trigger waveform to the second burst during the plurality of first trigger pulses in the second burst used to compute the second repetition rate.

36. A method of clause 32 wherein applying a first trigger waveform comprises applying a first applied waveform applied during the first burst as the first trigger waveform.

37. A method of clause 32 wherein applying a first trigger waveform comprises applying a default waveform as the first trigger waveform.

38. A method of clause 32 wherein applying a first trigger waveform comprises applying a constant level as the first trigger waveform.

39. A method of clause 32 further comprising managing a transition between the first trigger waveform and the second applied waveform.

40. A method of clause 39 wherein managing a transition between the first trigger waveform and the second applied waveform comprises cross fading the first trigger waveform and the second applied waveform.

41. A method of clause 39 wherein managing a transition between the first trigger waveform and the second applied waveform comprises switching from the first trigger waveform to the second applied waveform at a zero crossing of the first trigger waveform.

42. A method of clause 39 wherein managing a transition between the first trigger waveform and the second applied waveform comprises switching from the first trigger waveform to the second applied waveform at a local maximum or minim of the first trigger waveform.

1. A laser system comprising:
a trigger circuit for firing the laser system in at least two bursts, a first burst including a plurality of first burst pulses fired at a first repetition rate and a second burst including a plurality of second burst pulses fired at a second repetition rate;
a wavelength control device adapted to control a respective wavelength of each of the first burst pulses in response to a first applied waveform and of each of the second burst pulses in response to a second applied waveform; and
a comparator for performing a comparison between the second repetition rate and the first repetition rate and for determining one or more parameters of the second applied waveform at least partially on the basis of the comparison.

2. A laser system as claimed in claim 1 wherein the comparator determines to use a second applied waveform different from the first applied waveform if the second repetition rate is different from the first repetition rate.

3. A laser system as claimed in claim 1 wherein the comparator determines to use a second applied waveform the same as the first applied waveform if the second repetition rate is the same as the first repetition rate.

4. (canceled)

5. A laser system as claimed in claim 3 wherein the comparator comprises a field programmable gate array that determines one or more parameters for the second applied waveform based at least in part on the second repetition rate.

6. A laser system as claimed in claim 3 wherein the comparator comprises a memory having a look-up table and wherein the look-up table returns one or more parameters for the second applied waveform based on the second repetition rate.

7. A laser system as claimed in claim 6 wherein the one or more parameters include a magnitude of an amplitude of the second applied waveform or a time variation of a magnitude of an amplitude of the second applied waveform.

8. (canceled)

9. A laser system as claimed in claim 6 wherein the one or more parameters include a correction to a feedback algorithm for the second applied waveform.

10. (canceled)

11. A laser system as claimed in claim 9 wherein the comparator applies the second applied waveform to the second burst after a plurality of trigger pulses in the second burst has been used to compute the second repetition rate.

12. (canceled)

13. A laser system as claimed in claim 9 wherein the comparator applies a first trigger waveform applied during the first burst to the second burst after the plurality of trigger pulses in the second burst has been used to compute the second repetition rate.

14. A laser system as claimed in claim 13 wherein the comparator applies the first applied waveform as the first trigger waveform.

15. (canceled)

16. (canceled)

17. A laser system as claimed in claim 13 further comprising a transition management unit for managing a transition between the first trigger waveform and the second applied waveform.

18. A laser system as claimed in claim 17 wherein the transition management unit manages the transition between the first trigger waveform and the second applied waveform by cross fading the first trigger waveform and the second applied waveform.

19. (canceled)

20. (canceled)

21. A method of controlling a laser system, the method comprising:
firing the laser system in a first burst including a plurality of first burst pulses fired at a first repetition rate;
initiating firing the laser system in a second burst including a plurality of second burst pulses while determining a second repetition rate at which the second burst pulses are fired;
using the second repetition rate to determine one or more parameters for a second burst waveform for an actuator determining wavelengths of the second burst pulses; and
applying the second burst waveform to the actuator.

22. A method as claimed in claim 21 wherein using the second repetition rate to determine one or more parameters for a second burst waveform comprises determining one or more parameters for the second burst waveform different from one or more parameters of a first burst waveform.

23. A method as claimed in claim 21 wherein using the second repetition rate to determine one or more parameters for a second burst waveform comprises determining parameters for the second burst waveform which are the same as the parameters of a first burst waveform.

24. (canceled)

25. A method as claimed in claim 21 wherein using the second repetition rate to determine one or more parameters for a second burst waveform for an actuator determining wavelengths of the second burst pulses comprises using the second repetition rate as an input to a field programmable gate array to determine parameters for the second burst waveform.

26. A method as claimed in claim 21 wherein using the second repetition rate to determine one or more parameters for a second burst waveform for an actuator determining wavelengths of the second burst pulses comprises using the second repetition rate to look up parameters for the second burst waveform in a look-up table.

27. A method as claimed in claim 21 wherein the one more parameters include a magnitude of an amplitude of the second burst waveform or a time variation of a magnitude of an amplitude of the second burst waveform.

28. (canceled)

29. A method as claimed in claim 21 wherein the one or more parameters include a correction to a feedback algorithm for the second burst waveform.

30. (canceled)

31. A method as claimed in claim 21 further comprising using a plurality of first trigger pulses in the second burst to compute the second repetition rate before using the second repetition rate to determine one or more parameters for a second burst waveform for an actuator determining wavelengths of the second burst pulses.

32. A method as claimed in claim 31 further comprising applying a first trigger waveform to the second burst during the plurality of first trigger pulses in the second burst used to compute the second repetition rate.

33. (canceled)

34. (canceled)

35. A method as claimed in claim 32 wherein applying a first trigger waveform comprises applying a first trigger waveform to the second burst during the plurality of first trigger pulses in the second burst used to compute the second repetition rate.

36. A method as claimed in claim 32 wherein applying a first trigger waveform comprises applying a first applied waveform applied during the first burst as the first trigger waveform or applying a default waveform as the first trigger waveform.

37. (canceled)

38. (canceled)

39. (canceled)

40. A method as claimed in claim 32 further comprising managing a transition between the first trigger waveform and the second applied waveform by cross fading the first trigger waveform and the second applied waveform.

41. A method as claimed in claim 32 further comprising managing a transition between the first trigger waveform and the second applied waveform by switching from the first trigger waveform to the second applied waveform at a zero crossing of the first trigger waveform.

42. (canceled)
